(19) United States
(12) Patent Application Publication
(10) Pub. No.: US 2010/0059020 A1
(43) Pub. Date: Mar. 11, 2010

(54) FUEL SUPPLY SYSTEM AND FUEL SUPPLY CONTROL METHOD FOR INTERNAL COMBUSTION ENGINE

(75) Inventors: Tetsuro Serai, Nukata-gun (JP); Noriyasu Amano, Gamagori-city (JP); Hiroki Fujieda, Okazaki-city (JP); Hiroshi Nakamura, Nishio-city (JP); Akikazu Uchida, Kariya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/552,012

(22) Filed: Sep. 1, 2009

(30) Foreign Application Priority Data
Sep. 5, 2008 (JP) 2008-228875

(51) Int. Cl. F02M 59/36; F02M 37/00; F02D 41/30

(52) U.S. Cl. 123/458; 123/515; 701/109

(57) ABSTRACT

At the time of shifting a fuel property value associated with a first imaginary passage cell as a fuel property value associated with a second imaginary passage cell located on the downstream side thereof, the fuel property value associated with the second imaginary passage cell is corrected in a controller by computing a difference between the fuel property value associated with the first imaginary passage cell and the fuel property value associated with the second imaginary passage cell and multiplying the difference by a correction coefficient. A stoichiometric air/fuel ratio is computed in the controller based on the fuel property value, which is associated with a last one of the imaginary passage cells. Fuel injection of an injector is controlled by the controller based on a computed injection quantity of fuel, which is computed based on the stoichiometric air/fuel ratio.

### CROSS REFERENCE TO RELATED APPLICATION

This application is based on and incorporates herein by reference Japanese Patent Application No. 2008-228875 filed on Sep. 5, 2008.

### BACKGROUND OF THE INVENTION

1. Field of the Invention

The present invention relates to a fuel supply system and a fuel supply control method for an internal combustion engine.

2. Description of Related Art

In a previously proposed fuel supply system of an internal combustion engine, a fuel property sensor (e.g., an alcohol concentration sensor) is installed to a pipe, which forms a fuel supply line and supplies fuel to injectors of the internal combustion engine. A portion of the pipe between the fuel property sensor and one of the injectors is equally divided into a plurality of imaginary passage cells. An estimative stoichiometric air/fuel ratio is computed based on a current measurement value of the fuel property sensor. The fuel property value indicating the stoichiometric air/fuel ratio is stored into a first one of first-in first-out (FIFO) storage cells of a storage device. A quantity of fuel, which is consumed by the respective injectors, i.e., which is injected from the respective injectors into a corresponding cylinder of the internal combustion engine, is computed based on the stoichiometric air/fuel ratio. The fuel property value of each storage cell, which indicates the stoichiometric air/fuel ratio, is sequentially transferred to its adjacent downstream side storage cell every time the quantity of fuel, which is consumed by the injectors, becomes equal to or larger than a volume of one passage cell. When the volumes of fuel in a predetermined number of passage cells are consumed, the target air/fuel ratio is adjusted based on the estimative stoichiometric air/fuel ratio. For example, Japanese Unexamined Patent Publication No. H11-315744 (corresponding to U.S. Pat. No. 5,934,255) teaches such a fuel supply system.

One previously proposed fuel supply system of the above kind will now be described in detail with reference to FIG. 8. The previously proposed fuel supply system is applied to an internal combustion engine 400, which can possibly use gasoline, alcohol or a mixture of gasoline and alcohol (serving as a fuel mixture of combustible liquids) as its fuel. As shown in FIG. 8, in the previously proposed fuel supply system, an alcohol concentration sensor 401, which serves as a fuel property sensor and senses an alcohol concentration (fuel property), is installed to a pipe 402, which conducts fuel pumped with a fuel pump 405 from a fuel tank 404 to injectors (only one of the injectors is shown for the sake of simplicity) 403 installed to the internal combustion engine 400. The alcohol concentration sensor 401 is electrically connected to a controller 406, and a measurement signal from the alcohol concentration sensor 401 is supplied to the controller 406. The controller 406 is also connected to a rotation sensor 407 for sensing a rotational speed of the engine 400, a mass air flow sensor 408 for sensing an intake air flow quantity and other undepicted sensors. The controller 406 computes the alcohol concentration of fuel based on a measurement signal received from the alcohol concentration sensor 401 and estimates a stoichiometric air/fuel ratio based on the computed alcohol concentration. A target air/fuel ratio is computed based on the estimative stoichiometric air/fuel ratio as well as the engine rotational speed and the intake air flow quantity, which are computed based on the measurement signals from the corresponding sensors. Then, the controller 406 drives the respective injectors 403 in a manner that implements the target air/fuel ratio. The computation of the estimative stoichiometric air/fuel ratio based on the alcohol concentration in the previously proposed fuel supply system will be described below.

In the case of the previously proposed fuel supply system, a volume of the portion of the pipe 402 from the alcohol concentration sensor 401 to one of the injectors 403 is equally divided into a predetermined number of imaginary passage cells. The alcohol concentration is computed every time a consumed quantity of fuel, which is consumed by the engine 400, reaches a volume of the respective passage cells, i.e., a volume of one passage cell. The estimative stoichiometric air/fuel ratio is computed based on this computed alcohol concentration and is stored in a first one of storage cells of a storage device of the controller 406 as a passage cell specific value, which is specific to a first one of the passage cells, at which the alcohol concentration sensor 401 is disposed. Next, the alcohol concentration is computed once again when the consumed quantity of fuel, which is consumed by the engine, reaches the volume of the one passage cell once again after the previous run. The estimative stoichiometric air/fuel ratio is computed based on this computed alcohol concentration and is stored as the passage cell specific value, which is specific to the first one of the passage cells, at which the alcohol concentration sensor 401 is disposed. At this time, the previously computed value, which has been stored in the storage cell that is assigned to the first one of the passage cells, at which the alcohol concentration sensor 401 is disposed, is transferred to the adjacent downstream side storage cell that is located on the downstream side (output side) of the storage cell assigned to the first one of the passage cells, at which the alcohol concentration sensor 401 is disposed. The above process may be kept repeated while the engine is running.

In the above process, the values, which are stored in the storage cells, are simultaneously transferred to the adjacent downstream side storage cells, except the downstream end storage cell (injector 403 side end storage cell). At the downstream end storage cell, which is assigned to the injector 403 side end passage cell, the previously stored value is discarded, i.e., erased without transferring it to another storage cell. Then, the value, which has been previously stored in the upstream side storage cell assigned to the passage cell located on the upstream side of the injector 403 side end passage cell, is transferred to and is stored in the downstream end storage cell assigned to the injector 403 side end passage cell. The controller 406 computes the target air/fuel ratio based on the estimative stoichiometric air fuel ratio, which is the specific value stored in the downstream end storage cell assigned to the injector 403 side end passage cell. When only one of the gasoline and alcohol is supplied to the fuel tank 404 at the time of refueling, the alcohol concentration of fuel in the fuel tank 404 may be changed. Thus, even when the alcohol concentration sensor 401 senses a change in the alcohol concentration, the fuel portion, for which the change in the alcohol concentration is sensed with the alcohol concentration sensor 401, needs time to reach the injector 403 upon flowing through the pipe 402. Therefore, when the signal from the alcohol concentration sensor 401 is immediately reflected on the control operation of the injector 403, the operational state of the engine may possibly become inappropriate during the above time lag period. According to the previously proposed technique, the alcohol concentration of fuel located adjacent to the injector 403 is estimated, and the target air/fuel ratio is computed based on the estimated alcohol concentration to always operate the engine at the more appropriate target air/fuel ratio.

In the previously proposed fuel supply system discussed above, the alcohol concentration and the estimative stoichiometric air/fuel ratio, which are obtained based on the measurement of the alcohol concentration sensor 401 and are stored in each corresponding storage cell are directly transferred to the adjacent downstream side storage cell without modification. This operation is based on an assumption of that the flow velocity of fuel in the pipe 402 is uniform along the cross-sectional area of the pipe 402. However, in reality, the flow velocity of fuel in the pipe 402 is not uniform along the cross-sectional area of the pipe 402. Specifically, the flow velocity of fuel is maximum in the center of the cross-sectional area of the pipe 402 and is progressively reduced toward an inner peripheral wall surface of the pipe 402 in the radial direction in the cross-sectional area of the pipe 402. Therefore, it is conceivable that the alcohol concentration and the estimative stoichiometric air/fuel ratio should show gradual changes from one storage cell to another storage cell and thereby should not be simply transferred from the one storage cell to the other storage cell in response to the progress of the consumption of fuel in the engine 400.

In view of the above discussion, a result of experiments conducted by the inventors of the present application will be discussed with reference to FIG. 9. In the graph shown in FIG. 9, an axis of ordinates indicates a volume concentration of alcohol in the fuel, and an axis of abscissas indicates a flow quantity of fuel passed through the pipe (the passage cells). A solid line (characteristic line) S1 shown in FIG. 9 indicates a relationship between the measured alcohol concentration of fuel at the first one of the passage cells, at which the alcohol concentration sensor 401 is disposed, and the quantity of fuel passed through this passage cell. A dotted line (characteristic line) S2 shown in FIG. 9 indicates a relationship between the measured alcohol concentration of fuel at the last one of the passage cells, at which the injector 403 is disposed, and the quantity of fuel passed through this passage cell. In this experiment, the alcohol concentration of fuel supplied to the pipe is changed from 0% to 50%. Under this circumstance, the alcohol concentration of fuel in the first one of the passage cells, at which the alcohol concentration sensor 401 is disposed, and the alcohol concentration of fuel in the last one of the passage cells, at which the injector 403 is disposed, are measured. Furthermore, in FIG. 9, the characteristic line S1 and the characteristic line S2 are drawn such that the alcohol concentration change start time (see the point where the quantity of passed fuel is 0 ml in FIG. 9) of the characteristic line S1 and the alcohol concentration change start time of the characteristic line S2 coincide with each other. As clearly indicated by the characteristic line S1 in FIG. 9, the alcohol concentration is changed stepwise from 0% to 50% in the first one of the passage cells, at which the alcohol concentration sensor 401 is disposed. Thereafter, even though the quantity of fuel passed through this passage cell is increased, the alcohol concentration is stabilized at 50%. In contrast, as indicated by the characteristic line S2 in FIG. 9, in the last one of the passage cells, at which the injector 403 is disposed, although the alcohol concentration is increased upon increasing of the quantity of fuel passed through this passage cell, the alcohol concentration does not instantaneously reach 50%. Instead, the alcohol concentration is gradually increased in response to the increase in the quantity of fuel passed through the passage cell and finally reaches 50%. Thereafter, even when the quantity of fuel passed through the passage cell is increased further, the alcohol concentration is stabilized at 50%. That is, although the alcohol concentration is changed stepwise from 0% to 50%, the alcohol concentration does not instantaneously reach 50% in the last one of the passage cells, at which the injector 403 is disposed. Instead, the alcohol concentration in the last one of the passage cells, at which the injector 403 is disposed, is gradually increased from 0% and reaches 50% after the certain quantity of fuel passes the last one of the passage cells, at which the injector 403 is disposed.

In the case of the previously proposed alcohol concentration estimation method, the behavior of the alcohol concentration change at the time of flowing through the pipe is not taken into account. That is, in the case of the previously proposed alcohol concentration estimation method, it is assumed that the behavior of the alcohol concentration change in the passage cell, at which the alcohol concentration sensor is disposed, is the same as the behavior of the alcohol concentration change in the passage cell, to which the injector is directly connected. Therefore, it is difficult to drive the engine at the appropriate target air/fuel ratio.

### SUMMARY OF THE INVENTION

The present invention addresses the above disadvantage. According to the present invention, there may be provided a fuel supply system for an internal combustion engine, which is adapted to use a mixture of a plurality types of combustible liquids as its fuel. The fuel supply system includes a fuel pump, an injector, a fuel supply line, a fuel property sensor, a fuel consumption computing means, a fuel property estimating means and an injector driving means. The fuel pump pumps fuel from a fuel tank. The injector is installed to the internal combustion engine and injects the fuel received from the fuel pump into a combustion chamber of the internal combustion engine. The fuel supply line communicates between the fuel pump and the injector. The fuel property sensor is installed to the fuel supply line and outputs a measurement signal indicating a property of the fuel that flows through the fuel supply line. The fuel consumption computing means is for computing a consumed quantity of fuel, which is consumed by the internal combustion engine. The fuel property estimating means is for computing a fuel property value of the fuel based on a measurement signal received from the fuel property sensor every time the consumed quantity of fuel reaches a value equal to a volume of each of a plurality of imaginary passage cells, which have equal volumes, respectively, and are arranged one after another in a flow direction of the fuel in a portion of the fuel supply line that extends from the fuel property sensor to the injector. The fuel property estimating means stores the computed fuel property value as a current fuel property value associated with a first one of the plurality of imaginary passage cells, which is closest to the fuel property sensor among the plurality of imaginary passage cells. The fuel property estimating means sequentially shifts each fuel property value stored in association with a corresponding one of the plurality of imaginary passage cells as a fuel property value associated with an adjacent downstream side one of the plurality of imaginary passage cells located on a downstream side thereof every time the consumed quantity of fuel reaches the value equal to the volume of each imaginary passage cell. When the fuel property estimating means shifts the fuel property value associated with the first one of the plurality of imaginary passage cells as a fuel property value associated with a second one of the plurality of imaginary passage cells located on the downstream side of the first one of the plurality of imaginary passage cells, the fuel property estimating means corrects the fuel property value associated with the second one of the plurality of imaginary passage cells by computing a difference between the fuel property value associated with the first one of the plurality of imaginary passage cells and the fuel property value associated with the second one of the plurality of imaginary passage cells and multiplying the difference by a correction coefficient. The injector driving means is for driving the injector. The injector driving means computes a stoichiometric air/fuel ratio based on the fuel property value, which is associated with a last one of the plurality of imaginary passage cells that is closest to the injector among the plurality of imaginary passage cells, and then computes an injection quantity of fuel based on the computed stoichiometric air/fuel ratio. The injector driving means drives the injector based on the computed injection quantity of fuel.

According to the present invention, there may be alternatively provided a fuel supply system for an internal combustion engine, which is adapted to use any one of alcohol fuel, non-alcohol liquid fuel and a mixture of the alcohol fuel and the non-alcohol liquid fuel as its fuel. The fuel supply system includes an injector, a fuel supply line, an alcohol concentration sensor and a controller. The injector is installed to the internal combustion engine and injects fuel into a combustion chamber of the internal combustion engine. The fuel supply line supplies the fuel to the injector. The alcohol concentration sensor is installed to the fuel supply line and outputs a measurement signal, which indicates an alcohol concentration of the fuel conducted through the fuel supply line. The controller computes and stores a fuel-specific value, which is one of the alcohol concentration of the fuel and a value derived from the alcohol concentration of the fuel, based on the measurement signal received from the alcohol concentration sensor every time the internal combustion engine consumes a predetermined quantity of fuel through injection of the fuel from the injector, so that a plurality of fuel-specific values is stored in the controller after execution of the computation of the fuel-specific value a plurality of times. When the controller determines that a difference between one of the plurality of fuel-specific values and a subsequently computed one of the plurality of fuel-specific values is equal to or larger than a preset value, the controller corrects the subsequently computed one of the plurality of fuel-specific values in a manner that reduces the difference between the one of the plurality of fuel-specific values and the subsequently computed one of the plurality of fuel-specific values. The controller controls fuel injection of the injector based on the subsequently computed one of the plurality of fuel-specific values at time of injecting the fuel, which corresponds to the subsequently computed one of the plurality of fuel-specific values.

According to the present invention, there may be also provided a fuel supply control method for controlling fuel supply at an internal combustion engine, which is adapted to use any one of alcohol fuel, non-alcohol liquid fuel and a mixture of the alcohol fuel and the non-alcohol liquid fuel as its fuel. According to the fuel supply control method, a fuel-specific value, which is one of an alcohol concentration of the fuel and a value derived from the alcohol concentration of the fuel, is computed and stored based on a measurement signal received from an alcohol concentration sensor installed to a fuel supply line connected to an injector every time the internal combustion engine consumes a predetermined quantity of fuel through injection of the fuel from the injector, so that a plurality of fuel-specific values is stored after execution of the computation of the fuel-specific value a plurality of times. Then, a difference between one of the plurality of fuel-specific values and a subsequently computed one of the plurality of fuel-specific values is computed. Thereafter, the subsequently computed one of the plurality of fuel-specific values is corrected in a manner that reduces the difference between the one of the plurality of fuel-specific values and the subsequently computed one of the plurality of fuel-specific values when the difference between the one of the plurality of fuel-specific values and the subsequently computed one of the plurality of fuel-specific values is equal to or larger than a preset value. Fuel injection of the injector is controlled based on the subsequently computed one of the plurality of fuel-specific values at time of injecting the fuel, which corresponds to the subsequently computed one of the plurality of fuel-specific values.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a fuel supply system applied to an internal combustion engine according to a first embodiment of the present invention;

FIG. 2 is a flowchart showing ethanol concentration computation and target air/fuel ratio computation executed by a controller of the fuel supply system according to the first embodiment;

FIG. 3 is a schematic diagram showing a fuel line of the fuel supply system divided into a plurality of imaginary passage cells respectively associated with storage cells of a storage device of a controller according to the first embodiment;

FIG. 4 is a schematic diagram showing a fuel supply system applied to an internal combustion engine according to a second embodiment of the present invention;

FIG. 5 is a flowchart showing ethanol concentration computation and target air/fuel ratio computation executed by a controller of the fuel supply system according to the second embodiment;

FIG. 6 is a schematic diagram showing a fuel line of the fuel supply system divided into a plurality of imaginary passage cells respectively associated with storage cells of a storage device of a controller according to the second embodiment;

FIG. 7 is a flowchart showing a modification of the first embodiment;

FIG. 8 is a schematic diagram showing a previously proposed fuel supply system applied to an internal combustion engine; and

FIG. 9 is a diagram showing a relationship between a volume concentration of alcohol in fuel conducted through a fuel pipe and a flow quantity of fuel that passes passage cells in the fuel supply pipe.

### DETAILED DESCRIPTION OF THE INVENTION

Various embodiments of the present invention, in which a fuel supply system and a fuel supply control method of the present invention are applied to an internal combustion engine (hereinafter, simply referred to as an engine) 1 of a vehicle, will be described with reference to the accompanying drawings.

### First Embodiment

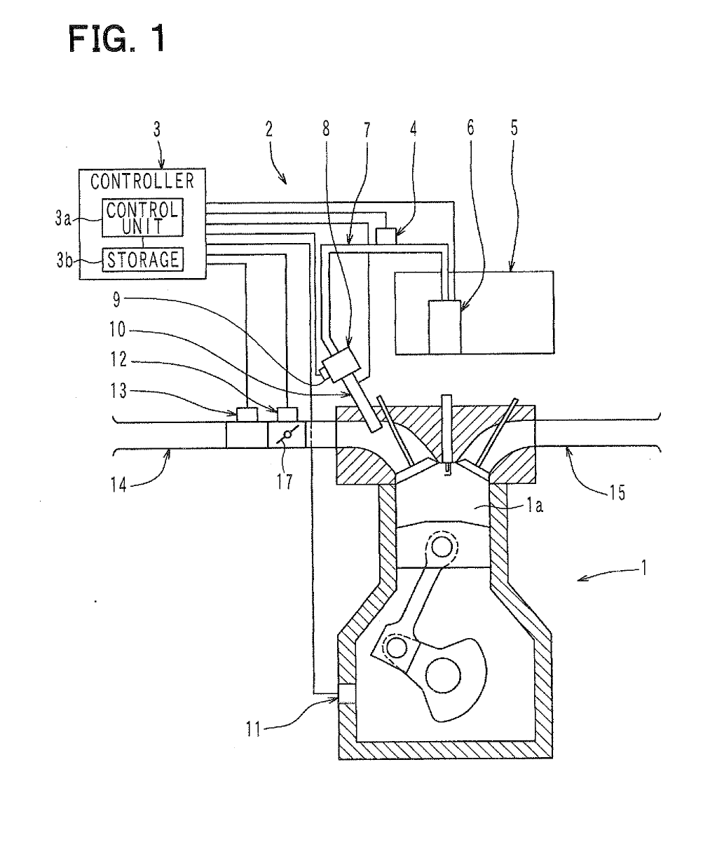

According to a first embodiment of the present invention, the engine 1 is a spark ignition engine, which can use a fuel mixture of multiple types of combustible liquids as its fuel. In this particular embodiment, the fuel mixture is a mixture of gasoline (non-alcohol liquid fuel) and ethanol (alcohol fuel). Thus, the engine 1 can use gasoline, ethanol or the mixture of gasoline and ethanol as its fuel in this instance. The engine 1 is controlled through a controller (a control device) 3. As shown in FIG. 1, the engine 1 has a fuel rail 8 and a plurality of fuel injection valves, i.e., injectors (only one of the injectors is shown for the sake of simplicity) 10. The injectors 10 are communicated with the fuel rail 8 and are provided to cylinders, respectively, of the engine 1 to inject fuel into combustion chambers 1a defined in the cylinders.

As shown in FIG. 1, the fuel supply system 2 has the fuel rail 8, a fuel rail pressure sensor 9, a fuel line 7, an ethanol concentration sensor (a fuel property sensor) 4, a fuel tank 5 and a fuel pump 6. The fuel rail pressure sensor 9 is installed to the fuel rail 8 to measure the fuel pressure therein. The fuel line 7 is a fuel pipe, which is connected to the fuel rail 8 to form a fuel pipe line, i.e., a fuel supply line. The ethanol concentration sensor 4 is installed to the fuel line 7 to measure an ethanol concentration of the fuel flowing through the fuel line 7. The fuel tank 5 receives fuel. The fuel pump 6 pumps the fuel from the fuel tank 5 to the fuel rail 8 through the fuel line 7. In the fuel supply system 2 of the present embodiment, the fuel pump 6 is securely received in the fuel tank 5.

As shown in FIG. 1, the engine 1 is provided with various sensing devices, such as a rotation sensor 11, an airflow meter 13 and a throttle valve position sensor 12. The rotation sensor 11 senses a rotational speed of the engine. The airflow meter 13 is provided to an intake pipe 14 of the engine 1 and senses an intake air quantity. The throttle valve position sensor 12 is provided to the intake pipe 14 and senses an opening degree of a throttle valve 17 disposed in the intake pipe 14.

The controller 3 is constructed as an ordinary microcomputer and has a control unit (CPU) 3a, a storage device (including ROM, RAM) 3b, an undepicted input/output (I/O) device and an undepicted bus line for connecting therebetween. The controller 3 outputs various control signals for controlling the engine 1 based on information received from the fuel rail pressure sensor 9, the rotation sensor 11, the throttle valve position sensor 12, the airflow meter 13, the ethanol concentration sensor 4 and other sensors (not shown). For example, the controller 3 outputs a drive signal to each injector 10 to inject a desired quantity of fuel from the injector 10 into the combustion chamber 1a of the corresponding cylinder. Also, the controller 3 outputs a drive signal to the fuel pump 6 to keep the pressure of the fuel rail 8 at a desired pressure.

Next, an operation of the fuel supply system 2 will be described. The fuel pump 6 is controlled by the controller 3 and thereby supplies fuel from the fuel tank 5 toward the fuel rail 8 through the fuel line 7. The fuel rail pressure sensor 9 outputs a measurement signal, which corresponds to the fuel pressure in the fuel rail 8. The controller 3 determines a target fuel rail pressure based on the information received from the sensors discussed above. Then, the controller 3 drives the fuel pump 6 such that the pressure of the fuel rail 8 is maintained at the target fuel pressure based on the determined target fuel rail pressure and the measurement signal of the fuel rail pressure sensor 9. The ethanol concentration sensor 4 outputs the measurement signal, which indicates the ethanol concentration (fuel property) of the fuel. The controller 3 determines a target air/fuel ratio based on the information from the sensors discussed above and the measurement signal of the ethanol concentration sensor 4. Then, the controller 3 adjusts the injection quantity of fuel to be injected from the injector 10 in such a manner that the engine 1 is driven at this target air/fuel ratio.

Now, the function of the ethanol concentration sensor 4 will be described. In general, the engine is controlled to combust the fuel at a stoichiometric air/fuel ratio to improve a thermal efficiency and to reduce contents of noxious components in the exhaust gas. In a case of an engine, which combusts only a single type of fuel, a stoichiometric air/fuel ratio of the fuel is known. Thus, the known stoichiometric air/fuel ratio is stored in the controller in advance, and the injection quantity of fuel is controlled based on the stoichiometric air/fuel ratio. In contrast, in the case of the engine, which can combust the fuel mixture of the multiple types of combustible liquids, such as the engine 1 having the fuel supply system of the first embodiment and being capable of combusting the fuel mixture of gasoline and ethanol, the stoichiometric air/fuel ratio of the fuel may possibly change during the operation of the engine 1. That is, in the market, gasoline, ethanol and a fuel mixture of gasoline and ethanol (having a constant mixing ratio of the gasoline and ethanol) are available. A user of the vehicle can freely choose fuel from these types of fuels to drive his/her vehicle. Therefore, the ethanol concentration (fuel property) of fuel in the fuel tank of the vehicle may change depending on which type of fuel is supplied to the fuel tank. Furthermore, the gasoline and ethanol have different stoichiometric air/fuel ratios, respectively. Specifically, the stoichiometric air/fuel ratio of the gasoline is 14.5 while the stoichiometric air/fuel ratio of the ethanol is 9. Thus, the stoichiometric air/fuel ratio of the fuel mixture of gasoline and ethanol changes depending on the ratio between gasoline and ethanol, i.e., depending on the ethanol concentration. Thus, in the fuel supply system 2 of the first embodiment, the ethanol concentration sensor 4 is installed to the fuel line 7, and the ethanol concentration of the fuel (fuel mixture) is computed based on the measurement signal received from the ethanol concentration sensor 4. Furthermore, the target air/fuel ratio, which is the stoichiometric air/fuel ratio of the fuel mixture of gasoline and ethanol, is computed based on the computed ethanol concentration. Then, the controller 3 adjusts the injection quantity of fuel (fuel mixture), which is injected from the injector 10, in such a manner that the engine 1 is operated at this target air/fuel ratio.

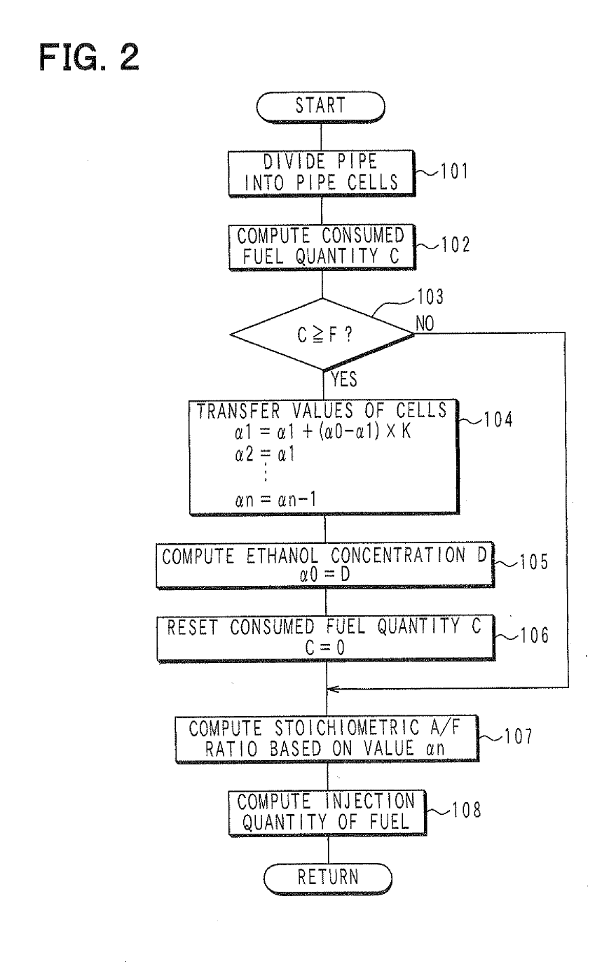

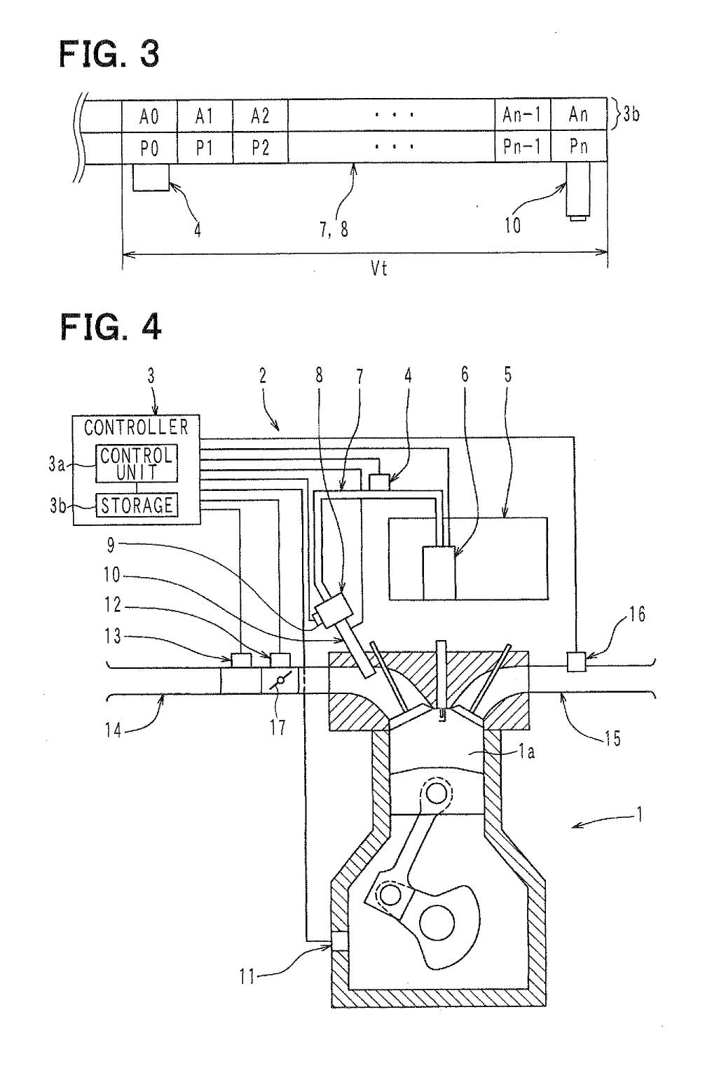

Next, the ethanol concentration computation and target air/fuel ratio computation executed by the controller 3 (more specifically, the control unit 3a) of the fuel supply system 2 of the first embodiment will be described with reference to FIGS. 2 and 3.

At step 101, a volume of the fuel passage from the location of the fuel line 7, at which the ethanol concentration sensor 4 is connected, to one of the injectors 10 is equally divided into a plurality of imaginary passage cells P0 to Pn (the total number of the passage cells is n+1 in this instance). Furthermore, storage cells of the storage device (more specifically, the RAM) 3b of the controller 3, which is controlled by the control unit 3a (more specifically, the CPU) of the controller 3, form first-in first-out (FIFO) storage cells, which includes a column of storage cells A0 to An, which are assigned to the passage cells P0 to Pn, respectively. Thus, the input side (left side in FIG. 3) and the output side (right side in FIG. 3) of these storage cells A0 to An correspond to the upstream side and the downstream side of the passage cells P0 to Pn.

Now, the operation at step 101 will be described in detail with reference to FIGS. 2 and 3. The volume Vt of the fuel passage from the location of the fuel line 7, at which the ethanol concentration sensor 4 is connected, to the injector 10 through the remaining portion of the fuel line 7 and the fuel rail 8 is equally divided by the predetermined number (the number of n+1). Therefore, as shown in FIG. 3, the imaginary passage cells P0 to Pn (the number of the passage cells is n+1), which have equal volumes and are placed one after another in series in the flow direction of the fuel, are created.

With reference to FIG. 3, a first one of the passage cells, to which the ethanol concentration sensor 4 is connected, is referred to as the passage cell P0. The passage cell P0 is closest to the ethanol concentration sensor 4 among the passage cells P0 to Pn. The subsequent passage cells, which are located after the passage cell P0 on the downstream side, are referred to as the passage cells P1 to Pn. The injector 10 is connected to the last passage cell Pn. The passage cell Pn is closest to the injector 10 among the passage cells P0 to Pn. In the case where the engine 1 includes the multiple injectors 10, the volume of the fuel passage from the location, at which the ethanol concentration sensor 4 is connected, to each of the injectors 10 may be obtained. Then, these volumes may be averaged to obtain the volume Vt. Alternatively, the volume of the fuel passage from the location, at which the ethanol concentration sensor 4 is disposed, to any representative one of the injectors 10 may be used as the volume Vt. The storage cells A0 to An, which respectively correspond to the passage cells P0 to Pn, store the ethanol concentration values of the fuel (fuel property values), respectively, which are sequentially measured with the ethanol concentration sensor 4. Hereinafter, the values stored in the storage cells A0 to An, which correspond to the passage cells P0 to Pn, will be referred to as values α0 to αn, respectively.

At step 102, a consumed quantity (also referred to as a consumed fuel quantity) C of fuel, which is consumed by the engine 1, i.e., which is injected through the injectors 10, is computed. The consumed quantity C of fuel is computed by the controller 3 based on, for example, the drive signal supplied to the respective injectors 10.

Then, at step 103, it is determined whether the consumed quantity C of fuel, which is consumed by the engine 1, has reached to a volume F of one passage cell (a volume of one of the passage cells P0 to Pn). The volume F of the one passage cell is the volume, which is obtained by dividing the volume Vt by the number n+1. That is, the volume F of the one passage cell is obtained by the equation of F=Vt/(n+1). Here, for example, a counter may be used to record the consumed quantity C of fuel. Specifically, the injection quantity of fuel injected from each injector can be determined based on the target injection quantity of fuel of each injector. Therefore, every time each injector injects fuel, the injection quantity of fuel may be added, i.e., summed by using the counter. Then, when the value of the counter, i.e., the consumed quantity C of fuel reaches a value equal to the volume F of the one passage cell, it may be determined that the consumed quantity C of fuel reaches the volume F of the one passage cell. Thereafter, the counter may be reset (see step 106 discussed below).

When it is determined that the consumed quantity C of fuel is equal to or larger than the volume F of the one passage cell (i.e., C≧F) at step 103, the operation proceeds to step 104. At step 104, the value stored in each storage cell is shifted, i.e., is transferred to an adjacent one of the storage cells, which corresponds to the passage cell located on the downstream side of the current passage cell, i.e., on the injector 10 side of the current passage cell. In other words, each fuel property value stored in association with a corresponding one of the plurality of imaginary passage cells is shifted as a fuel property value associated with an adjacent downstream side one of the plurality of imaginary passage cells located on a downstream side thereof every time the consumed quantity C of fuel reaches the value equal to the volume F of each imaginary passage cell.

The transfer of the value from the one storage cell to the adjacent downstream side storage cell executed at step 104 will be described further in detail. In this instance, it is assumed that the large alcohol concentration change, such as one similar to that of FIG. 9, occurs at the time of measuring the alcohol concentration value α0, so that the value α0 may be substantially increased from the previous value. The values α1 to αn−1, which are respectively stored in the storage cells A1 to An−1, are now transferred to the corresponding adjacent downstream side storage cells A2 to An, respectively, without any modification thereof. Specifically, the value α1, which has been stored in the storage cell A1 corresponding to the passage cell P1, is transferred to the storage cell A2 corresponding to the passage cell P2 and becomes the new value α2. Also, the value α2, which has been stored in the storage cell A2 corresponding to the passage cell P2, is transferred to the storage cell A3 corresponding to the passage cell P3 and becomes the new value α3. Thereafter, the value αn−1, which has been stored in the storage cell An−1 corresponding to the passage cell Pn−1, is transferred to the storage cell An corresponding to the passage cell Pn and becomes the new value αn. At this time, the previous value αn, which has been previously stored in the storage cell An corresponding to the passage cell Pn, is discarded (erased). Unlike the other storage cells A1 to An discussed above, the value α0, which has been stored in the storage cell A0 corresponding to the passage cell P0, is not directly transferred to the storage cell A1 corresponding to the passage cell P1. Rather, the value α0 is processed through a predetermined arithmetic process and is then transferred to the storage cell A1 corresponding to the passage cell P1 as the new value α1. That is, as shown at step 104 of FIG. 2, this new value α1 is computed as a sum of the previous value α1 and a correction value, which is obtained by multiplying a difference between the previous value α0 and the previous value α1 by a correction coefficient K. The correction coefficient K is a real number, which is larger than 0 and is smaller than 1. Therefore, the new value α1 of the storage cell A1, which is computed based on the previous value α0 stored in the storage cell A0, becomes smaller than the previous value α0. Then, the new value α1 of the storage cell A1, which is computed by using the previous value α0 and the correction coefficient K, is sequentially transferred to the adjacent downstream side storage cell (in the order of the storage cell A2 corresponding to the passage cell P2, the storage cell A3 corresponding to the passage cell P3 and the like) every time the consumed quantity C of fuel reaches the volume F of the one passage cell (the volume of each passage cell) and is finally transferred to the storage cell An corresponding to the passage cell Pn.

Then, at step 105, a first fuel property estimation process is executed. Specifically, the ethanol concentration D is computed based on the measurement signal of the ethanol concentration sensor 4, and the computed ethanol concentration D is stored as the new value α0 in the storage cell A0 corresponding to the passage cell P0.

Next, at step 106, the consumed quantity C of fuel is rest to zero (i.e., C=0).

Thereafter, at step 107, the stoichiometric air/fuel ratio of the fuel mixture of gasoline and ethanol, which is supplied to the engine 1 as the fuel, is computed based on the ethanol concentration, i.e., the value αn stored in the storage cell An corresponding to the passage cell Pn that is closest to the injector 10 among the passage cells P0 to Pn.

Then, at step 108, the injection quantity of fuel (the target injection quantity of fuel), which is injected from the injector 10 into the combustion chamber of the corresponding cylinder of the engine, is computed based on the stoichiometric air/fuel ratio, which is computed at step 107, and the controller 3 outputs the drive signal to the injector 10 based on this injection quantity of fuel. Thereafter, the controller 3 returns to step 101 and repeats the entire operation shown in FIG. 2.

When it is determined that the consumed quantity C of fuel is smaller than the volume F of the one passage cell (i.e., C<F) at step 103, the operation proceeds to step 107 discussed above.

In the fuel supply system 2 of the first embodiment described above, the ethanol concentration sensor 4 is installed to the fuel line 7, which supplies the fuel to the injectors 10. The imaginary passage cells P0 to Pn are created by equally dividing the volume of the fuel supply passage, which is located from the ethanol concentration sensor 4 to the injector 10, by the predetermined number (i.e., n+1). The ethanol concentration value (the fuel property value) of each storage cell is transferred to its adjacent downstream side storage cell every time the consumed quantity C of fuel at the engine 1 reaches the volume F of the one passage cell. The stoichiometric air/fuel ratio is computed based on the ethanol concentration value, which is stored in the storage cell An corresponding to the passage cell Pn directly connected to the injector 10. Then, the injection quantity of fuel, which is injected from the injector 10 into the corresponding cylinder of the engine 1, is computed based on this stoichiometric air/fuel ratio, and the drive signal is outputted to the injector 10 based on this injection quantity of fuel. Furthermore, in the fuel supply system 2 of the first embodiment, in the process of transferring the ethanol concentration value of each storage cell to the adjacent downstream side storage cell, only at the time of transferring the value α0 of the storage cell A0 corresponding to the passage cell P0, at which the ethanol concentration sensor 4 is disposed, to its adjacent downstream side storage cell A1 corresponding to the passage cell P1, the value α0 is corrected and is transferred to the adjacent downstream side storage cell A1 corresponding to the passage cell P1. That is, the value of the storage cell A1 after the transferring is computed as the sum of the previous value α1 and the correction value, which is obtained by multiplying the difference between the previous value α0 and the previous value α1 by the correction coefficient K, which is 0<K<1. In this way, immediately after the transferring of the ethanol concentration value of each storage cell to its adjacent downstream side storage cell, the value α1 of the storage cell A1 corresponding to the passage cell P1 becomes smaller than the value α0 of the previous storage cell A0 corresponding to the passage cell P0. This is due to the following reason.

That is, the fuel flow in the actual fuel supply pipe does not have the uniform flow velocity throughout the cross-sectional area of the pipe, which extends in an imaginary plane that is perpendicular to the longitudinal direction of the pipe. Specifically, the flow velocity of fuel is maximum in the center of the cross-sectional area of the pipe and is progressively reduced toward the pipe wall in the cross-sectional area of the pipe. Thus, when the ethanol concentration of fuel is changed at the time of, for example, refueling, the change rate of the ethanol concentration, which is sensed with the ethanol concentration sensor 4, is not kept constant along the length of the fuel supply pipe. Instead, the change rate of the ethanol concentration, which is sensed with the ethanol concentration sensor 4, is gradually changed along the length of the fuel supply pipe. In view of the above point, according to the present embodiment, the sensed ethanol concentration, which is sensed with the ethanol concentration sensor 4 at the passage cell P0, is conducted to the passage cell Pn directly connected to the injector 10 as the lower ethanol concentration, which is lower than the sensed ethanol concentration, after the engine 1 consumes the predetermined portion of fuel held between the ethanol concentration sensor 4 and the injector 10 in the fuel supply pipe, i.e., the fuel supply line. After the consumption of this portion of fuel, the actual ethanol concentration at the passage cell Pn becomes the sensed ethanol concentration, which is initially sensed at the passage cell P0 with the ethanol concentration sensor 4.

Therefore, in the case of the previously proposed method where the value of the sensed ethanol concentration (the fuel property value) stored in the storage cell is simply transferred to the next downstream side storage cell (the next storage cell corresponding to the next passage cell located on the injector 10 side of the current passage cell) without the correction every time the consumed quantity C of fuel, which is consumed by the engine 1, reaches the volume F of the one passage cell, the following disadvantage may be encountered. That is, in the case where the ethanol concentration is changed due to, for example, the change in the type of supplied fuel at the time of refueling, the ethanol concentration of fuel, which is used in the stoichiometric air/fuel ratio computation process in the controller, differs from the actual ethanol concentration of fuel, which is injected from the injector 10, in the transitional period, during which the change in the ethanol concentration is conducted to the injector 10 side end passage cell after the time of consuming the remaining portion of fuel, which remains in the fuel supply pipe from the ethanol concentration sensor 4 to the injector 10 upon the sensing of the change in the ethanol concentration. Thus, it is difficult to maintain the appropriate engine performance.

In contrast, in the case of the fuel supply system 2 of the first embodiment, as discussed above, only when the value α0 of the storage cell A0 corresponding to the passage cell P0, to which the ethanol concentration sensor 4 is connected, is transferred to the adjacent downstream storage cell A1 corresponding to the passage cell P1, the value of the storage cell A1 corresponding to the passage cell P1 is computed as the sum of the previous value α1 and the correction value, which is obtained by multiplying the difference between the previous value α0 and the previous value α1 by the correction coefficient K at the time of occurrence of the substantial alcohol concentration change. Through this correction, even in the case where the ethanol concentration is changed, upon the consumption of the remaining portion of fuel, which remains in the fuel supply pipe from the ethanol concentration sensor 4 to the injector 10 at the time of sensing the ethanol concentration at the passage cell P0, it is possible to coincide the value αn of the passage cell Pn, i.e., the ethanol concentration, which is used in the stoichiometric air/fuel ratio consumption process, with the ethanol concentration of fuel located immediately before the injector 10 of the fuel rail 8, i.e., the fuel injected from the injector 10. Thus, there is provided the fuel supply system 2, which can maintain the appropriate engine performance.

As described above, according to the present embodiment, it is possible to provide the fuel supply system 2, which enables the more accurate estimation of the fuel property at the location immediately before the injector 10.

### Second Embodiment

FIG. 4 shows the fuel supply system 2 and the engine 1 associated therewith according to a second embodiment of the present invention. In the case of the engine 1, to which the fuel supply system 2 of the second embodiment is applied, an oxygen sensor (O₂ sensor) 16 is installed to the exhaust pipe 15 to sense the oxygen concentration in the exhaust gas conducted through the exhaust pipe 15. The remaining structure of the fuel supply system 2 of the second embodiment is substantially the same as that of the first embodiment and will not be discussed further for the sake of simplicity.

In the fuel supply system 2 of the second embodiment, the controller 3 senses the ethanol concentration based on the measurement signal received from the ethanol concentration sensor 4 in the first fuel property estimation process like in the case of the fuel supply system 2 of the first embodiment and computes the ethanol concentration based on the actual air/fuel ratio, which is computed based on the measurement signal of the oxygen sensor 16 in a second fuel property estimation process. The normal fuel injection control operation of the engine 1 is executed based on the stoichiometric air/fuel ratio that is computed based on the ethanol concentration, which is computed based on the measurement signal received from the ethanol concentration sensor 4. The computation of the ethanol concentration based on the measurement signal of the ethanol concentration sensor 4 is the same as that of the fuel supply system 2 of the first embodiment. In a case where the change rate of the ethanol concentration, which is computed based on the measurement signal of the ethanol concentration sensor 4, is large, i.e., in a case where an absolute value of the change rate is larger than a predetermined value, the correction of the ethanol concentration is carried out based on the ethanol concentration, which is computed based on the measurement signal of the ethanol concentration sensor 4, and ethanol concentration, which is computed based-on the actual air/fuel ratio computed based on the measurement signal from the oxygen sensor 16. Then, the fuel injection control operation is executed by computing the stoichiometric air/fuel ratio based on this corrected ethanol concentration.

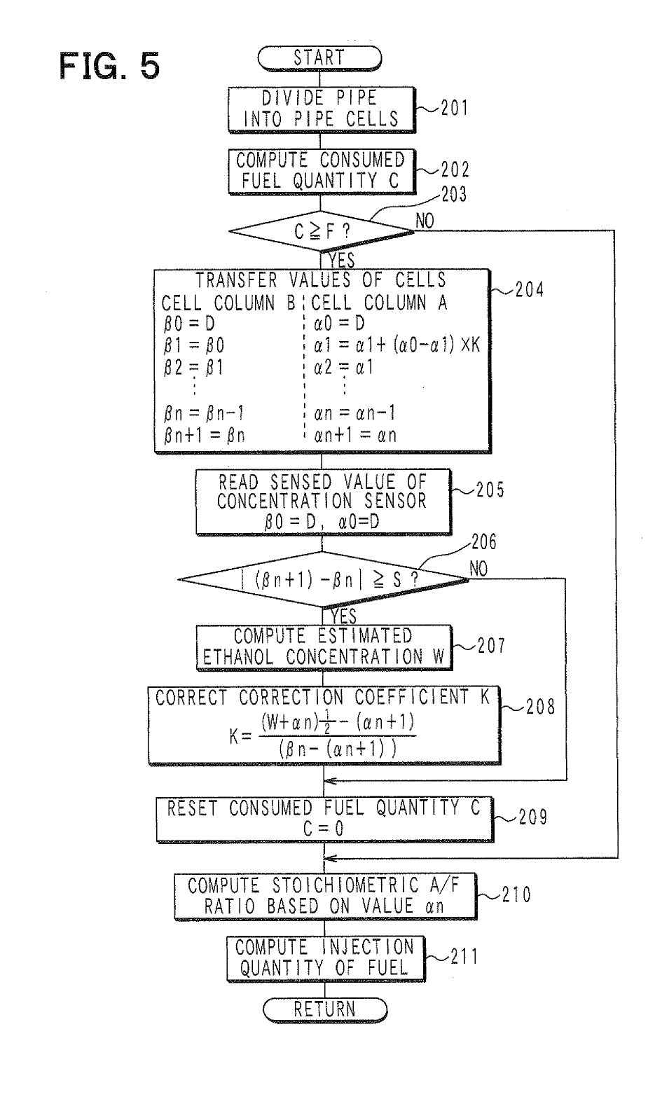

Next, the ethanol concentration computation and target air/fuel ratio computation executed by the controller 3 (more specifically, the control unit 3a) of the fuel supply system 2 of the second embodiment will be described with reference to FIG. 5. The following discussion is mainly focused on the different parts, which are different from those discussed with respect to the first embodiment, and the same parts, which are the same as those of the first embodiment, will not be discussed for the sake of simplicity.

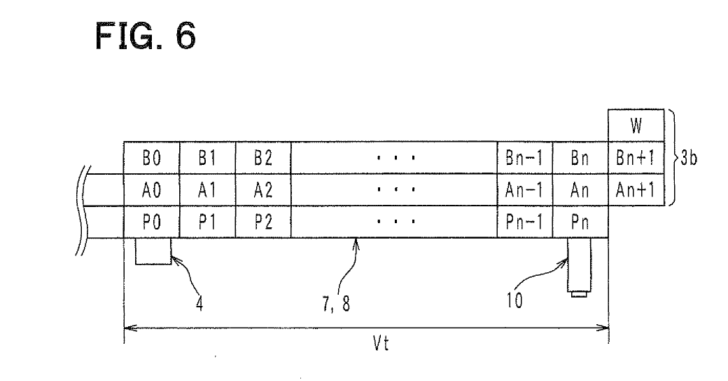

At step 201, similar to the first embodiment, the volume Vt of the fuel passage from the location of the fuel line 7, at which the ethanol concentration sensor 4 is connected, to the injector 10 is equally divided, so that a plurality of imaginary passage cells P0 to Pn (the total number of the passage cells is n+1) is creased, as shown in FIG. 6. The storage cells of the storage device (e.g., the RAM) 3a of the controller 3 form the FIFO storage cells, which include a column of storage cells A0 to An that are assigned to the passage cells P0 to Pn, respectively. The first one of the passage cells, to which the ethanol concentration sensor 4 is connected, is referred to as the passage cell P0. The subsequent passage cells, which are located after the passage cell P0, are referred to as the passage cells P1 to Pn. The injector 10 is connected to the last passage cell Pn. In the ethanol concentration computation and target air/fuel ratio computation of the second embodiment, an additional storage cell An+1 is provided in the column on the downstream side of the storage cell An corresponding to the passage cell Pn, to which the injector 10 is connected, as shown in FIG. 6. In the ethanol concentration computation and target air/fuel ratio computation of the second embodiment, an additional column (separate column) B of storage cells B0 to Bn+1, which correspond to the storage cells A0 to An+1 of the column A, respectively, are also created in the storage device 3b, as shown in FIG. 6. The storage cells A0 to An+1 respectively store the ethanol concentration values α0 to αn+1, which are computed in the ethanol concentration computation process executed by the controller 3 of the fuel supply system 2 like in the first embodiment. That is, the value of the storage cell A1 is computed as the sum of the previous value α1 and the correction value, which is obtained by multiplying the difference between the previous value α0 and the previous value α1 by the correction coefficient K (0<K<1). Furthermore, unlike the ethanol concentration values α0 to αn+1, which are stored in the storage cells A0 to An+1, respectively, the storage cells B0 to Bn+1 store uncorrected ethanol concentration values β0 to βn+1, which are simply obtained based on the measurement signal of the ethanol concentration sensor 4 without the correction in the manner similar to the case of the previously proposed fuel supply system.

At step 202, the consumed quantity C of fuel, which is consumed by the engine 1, i.e., which is injected through the injectors 10, is computed. The consumed quantity C of fuel is computed by the controller 3 based on, for example, the drive signal supplied to the respective injectors 10.

Then, at step 203, it is determined whether the consumed quantity C of fuel, which is consumed by the engine 1, has reached to the volume F of the one passage cell. Here, the volume F of each passage cell is the volume, which is obtained by dividing the volume Vt by the number n+1. That is, the volume F of the one passage cell is obtained by the equation of F=Vt/(n+1).

When it is determined that the consumed quantity C of fuel is equal to or larger than the volume F of the one passage cell (i.e., C≧F), the operation proceeds to step 204. At step 204, the values of the storage cells A0 to An+1 are transferred to the corresponding adjacent downstream side storage cells (the adjacent injector 10 side cells), respectively, and the values of the cells B0 to Bn+1 are transferred to the corresponding adjacent downstream side storage cells (the adjacent injector 10 side cells), respectively.

Here, it is assumed that the large alcohol concentration change occurs at the time of measuring the alcohol concentration value α0, so that the value α0 may be substantially increased from the previous value. First, the transferring of the values of the storage cells A0 to An+1 executed at step 204 will be described. The values α1 to αn, which are stored in the storage cells A1 to An, are directly transferred to the corresponding adjacent downstream side storage cells, respectively, without the modification. Specifically, the value α1, which has been stored in the storage cell A1, is transferred to the storage cell A2 and becomes as the new value α2. Also, the value α2, which has been stored in the storage cell A2, is transferred to the storage cell A3 and becomes the new value α3. Then, the previous value αn, which has been previously stored in the storage cell An, is transferred to the storage cell An+1 and becomes the value αn+1. At this time, the previous value αn+1, which has been previously stored in the storage cell An+1, is discarded (erased). In contrast, the value α0, which has been previously stored in the storage cell A0, is not directly transferred to the storage cell A1. Rather, the value α0 is processed through the predetermined arithmetic process and is then transferred to the storage cell A1 as the new value α1. That is, as shown at step 204 of FIG. 5, this new value α1 is computed as the sum of the previous value α1 and the correction value, which is obtained by multiplying the difference between the previous value α0 and the previous value α1 by the correction coefficient K. The correction coefficient K is the real number, which is larger than 0 and is smaller than 1. Therefore, the new value α1 of the storage cell A1, which is computed based on the previous value α0 stored in the storage cell A0, becomes smaller than the previous value α0. Thereafter, the new value α1 of the storage cell A1, which is computed by using the previous value α0 and the correction coefficient K, is sequentially transferred to the adjacent downstream side storage cell (in the order of the storage cell A2, the storage cell A3 and the like) every time the consumed quantity C of fuel reaches the volume F of the one passage cell and is finally transferred to the storage cell An+1. In this case, the above process is the same as the storage cell to storage cell transferring process for transferring the ethanol concentration value discussed in the first embodiment except that the storage cell An+1 is added to the cell column A.

Next, the transferring of the values of the storage cells B0 to Bn+1 executed at step 204 will be described. The values β0 to βn+1, which are stored in the storage cells B0 to Bn+1, are directly transferred to the corresponding adjacent downstream side storage cells, respectively, without the modification. That is, the previous value β0, which has been stored in the storage cell B0, is transferred to the storage cell B1 and becomes the value β1. Also, the previous value β1, which has been stored in the storage cell B1, is transferred to the storage cell B2 and becomes the value β2. Then, the previous value βn, which has been previously stored in the storage cell Bn, is transferred to the storage cell Bn+1 and becomes the value βn+1. At this time, the previous value βn+1, which has been previously stored in the storage cell Bn+1, is discarded (erased).

Then, at step 205, the ethanol concentration D is computed based on the measurement signal of the ethanol concentration sensor 4, and the computed ethanol concentration D is stored as the new value α0 in the storage cell A0. At the same time, the computed ethanol concentration D is stored as the new value β0 in the storage cell β0.

Next, at step 206, it is determined whether the change rate of the ethanol concentration D is larger than the predetermined value. Specifically, it is determined whether the absolute value of the difference between the ethanol concentration value βn+1 (i.e., the value stored in the storage cell Bn+1 that is the last cell in the column B of the storage cells B0 to Bn+1) and the ethanol concentration value βn (i.e., the value stored in the storage cell Bn, which is next to the storage cell Bn+1 on the upstream side thereof and correspond to the passage cell Pn directly connected to the injector 10) is equal to or larger than a threshold value (a predetermined value) S.

When it is determined that the absolute value of the difference between the value βn and the value βn+1 is equal to or larger than the threshold value S at step 206, i.e., when it is sensed that the ethanol concentration D of fuel supplied to the injector 10 through the fuel line 7 is rapidly changed at step 206, the operation proceeds to step 207. In contrast, when it is determined that the absolute value of the difference between the value βn and the value βn+1 is smaller than the threshold value S at step 206, i.e., when it is sensed that the ethanol concentration D of fuel supplied to the injector 10 through the fuel line 7 is moderately changed at step 206, the operation proceeds to step 209.

At step 207, the actual air/fuel ratio, which is the air/fuel ratio in the operating state of the engine 1, is computed based on the measurement signal of the oxygen sensor 16 in the second fuel property estimation process. Then, the estimated ethanol concentration W is computed based on the actual air/fuel ratio. As shown in FIG. 6, the estimated ethanol concentration W, which is computed at step 207, corresponds to the value αn+1 that is stored in the storage cell An+1, i.e., the ethanol concentration, which is computed based on the measurement signal received from the ethanol concentration sensor 4.

Thereafter, at step 208, the value of the correction coefficient K is corrected according to the following equation.

$$K = \frac{( W + α n ) \frac{1}{2} - ( α n + 1 )}{( β n - ( α n + 1 ) )}$$

When the transferring of the values of the storage cells A0 to An+1 is executed at step 204 in the next run, this newly corrected correction coefficient K is applied to compute the value α1 to be stored in the storage cell A0.

Then, at step 209, the consumed quantity C of fuel is rest to zero (i.e., C=0).

Next, at step 210, the stoichiometric air/fuel ratio of the fuel mixture of gasoline and ethanol, which is supplied to the engine 1 as the fuel, is computed based on the ethanol concentration, i.e., the value αn stored in the storage cell An corresponding to the passage cell Pn that is closest to the injector 10.

Then, at step 211, the injection quantity of fuel, which is injected from the injector 10 into the corresponding cylinder of the engine, is computed based on the stoichiometric air/fuel ratio, which is computed at step 210, and the controller 3 outputs the drive signal to the injector 10 based on this injection quantity of fuel. Thereafter, the controller 3 returns to step 201 and repeats the entire operation shown in FIG. 5.

When it is determined that the consumed quantity C of fuel is smaller than the volume F of the one passage cell (i.e., C<F) at step 203, the operation proceeds to step 210.

Now, the discussion is made with respect to the advantages of the characteristic feature of the ethanol concentration computation and target air/fuel ratio computation, i.e., the advantages of the correcting process for correcting the correction coefficient K based on the estimated ethanol concentration W, which is computed based on the measurement signal of the oxygen sensor 16.

The computed ethanol concentration value, which is computed based on the measurement signal of the ethanol concentration sensor 4, may possibly become unstable due to the rapid change in the ethanol concentration (the fuel property), for example, right after the refueling for supplying the different type of fuel, which is different from the type of fuel that is already present in the fuel tank. In the case where the ethanol concentration is rapidly changed, when the injection quantity of fuel is computed based on the stoichiometric air/fuel ratio that is computed based only on the measurement signal of the ethanol concentration sensor 4, the ethanol concentration of fuel, which is actually injected from the injector 10 may possibly temporarily contradict with the ethanol concentration value stored in the storage cell An computed in the arithmetic process at the controller 3. In such a case, the engine performance may possibly be temporarily deteriorated from the best state.

In view of the above point, in the fuel supply system 2 of the second embodiment, when the change in the ethanol concentration is moderate, the ethanol concentration is computed based on the measurement signal of the ethanol concentration sensor 4. Furthermore, when the change in the ethanol concentration is large and rapid, the correction coefficient K, which is used in the computation of the ethanol concentration based on the measurement signal of the ethanol concentration sensor 4, is corrected based on the ethanol concentration, which is computed based on the measurement signal of the oxygen sensor 16. This correction of the correction coefficient K is executed such that the ethanol concentration, which is computed based on the measurement signal of the ethanol concentration sensor 4 upon correcting it through use of the correction coefficient K, is an arithmetic mean of the ethanol concentration D, which is computed based solely on the measurement signal of the ethanol concentration sensor 4, and the ethanol concentration W, which is computed based on the measurement signal of the oxygen sensor 16. That is, the new correction coefficient K is determined based on the equation discussed above with reference to step 208 of the flowchart shown in FIG. 5.

In the fuel supply system 2 of the second embodiment, through the above described control operation, even when the ethanol concentration is largely and rapidly changed, it is possible to coincide the ethanol concentration of fuel, which is actually injected from the injector 10, with the ethanol concentration of fuel, which is stored in the storage cell An and is computed in the arithmetic process at the controller 3. Thus, there is provided the fuel supply system 2, which can maintain the appropriate engine performance.

In the fuel supply system 2 of the second embodiment, the ethanol concentration, which is computed based on the measurement signal of the ethanol concentration sensor 4 upon correcting it through use of the correction coefficient K, becomes the arithmetic mean of the ethanol concentration D, which is computed based solely on the measurement signal of the ethanol concentration sensor 4, and the ethanol concentration W, which is computed based on the measurement signal of the oxygen sensor 16. Alternative to the arithmetic means of the ethanol concentration D and the ethanol concentration W, it is possible to use a geometric mean of these ethanol concentrations D, W. Further alternatively, it is possible to obtain the arithmetic mean or the geometric mean upon application of a predetermined coefficient to at least one of the ethanol concentration D and the ethanol concentration W.

In the fuel supply system 2 of the first and second embodiments, the gasoline and the ethanol are used as the combustible liquids (fuels). Alternatively, at least one of the gasoline and the ethanol may be replaced with another type of combustible liquid.

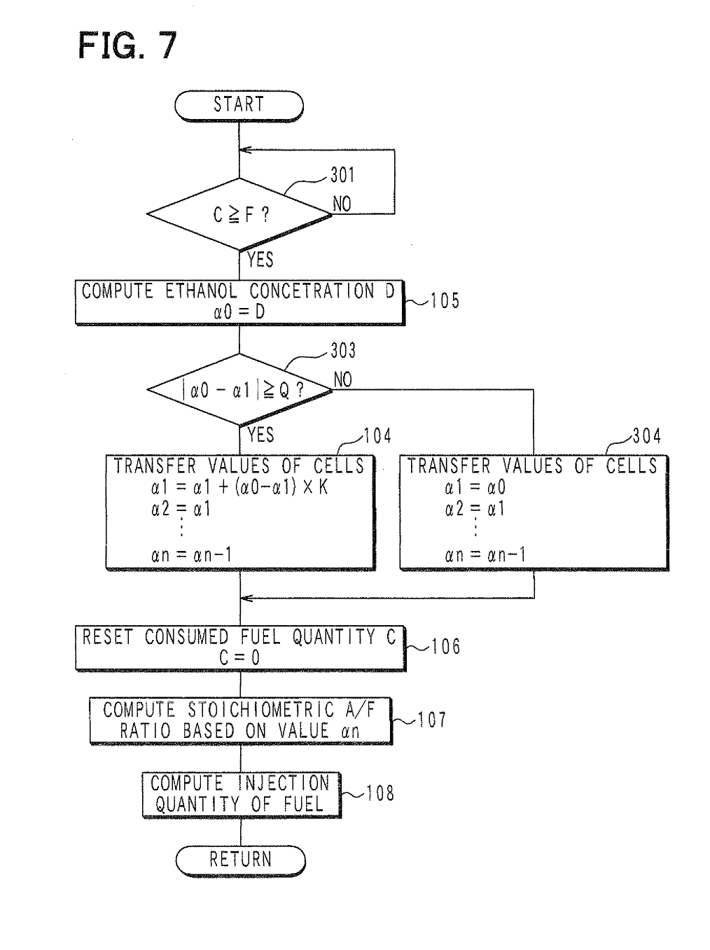

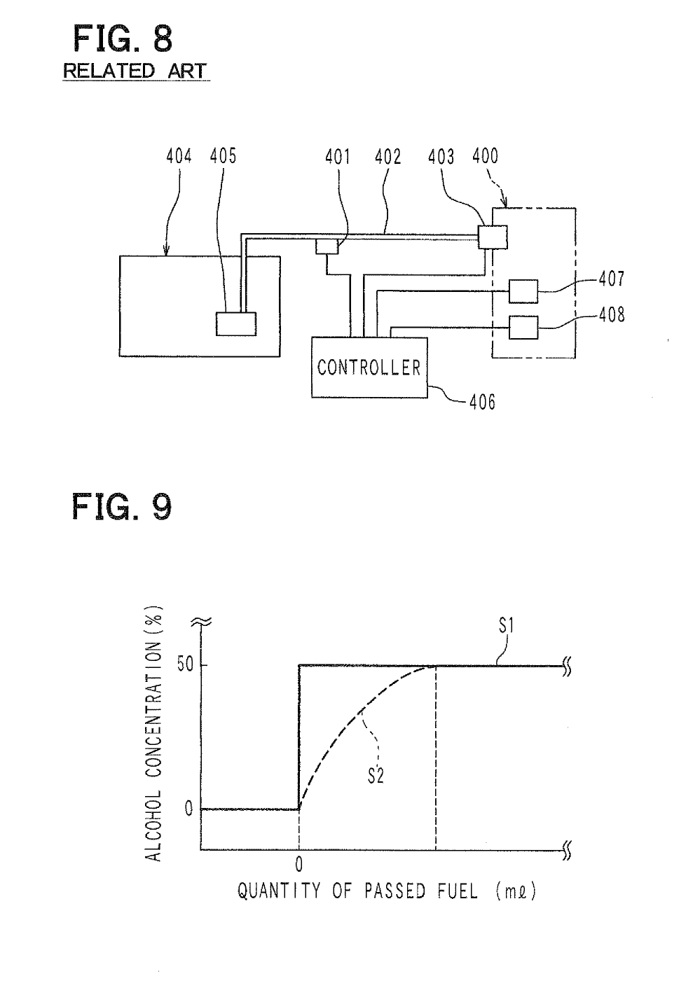

The first embodiment may be modified in a manner shown in FIG. 7. In FIG. 7, steps 104 to 108 are the same as steps 104 to 108 of the first embodiment shown in FIG. 2, and steps 301, 303, 304 are newly added. When the ignition key of the vehicle is turned on, the flowchart shown in FIG. 7 is started. Specifically, first, at step 301, it is determined whether the consumed quantity C of fuel, which is consumed by the engine, has reached to the volume F of the one passage cell. This step 301 may be a combination of steps 102-103 of the first embodiment. When it is determined that the consumed quantity C of fuel has not reached to the volume F of the one passage cell (i.e., NO at step 301), step 301 is repeated. In contrast, when it is determined that the consumed quantity C of fuel, which is consumed by the engine, has reached to the volume F of the one passage cell (i.e., YES at step 301), the operation proceeds to step 105. At step 105, the ethanol concentration D is computed based on the measurement signal of the ethanol concentration sensor 4, and the computed ethanol concentration D is stored as the new value α0 in the storage cell A0 corresponding to the passage cell P0.

Thereafter, the operation proceeds to step 303 where it is determined whether an absolute value of a difference between the value α0 stored in the storage cell A0 and the value α1 stored in the next storage cell A1 is equal to or larger than a preset value Q. When it is determined that the absolute value of the difference between the value α0 stored in the storage cell A0 and the value α1 stored in the next storage cell A1 is equal to or larger than the preset value Q at step 303 (i.e., YES at step 303), the operation proceeds to step 104 and then to steps 106 to 108. These steps 104 and 106 to 108 are the same as steps 104 and 106 to 108 discussed in the first embodiment with reference to FIG. 2. In contrast, when it is determined that the absolute value of the difference between the value α0 stored in the storage cell A0 and the value α1 stored in the next storage cell A1 is smaller than the preset value Q at step 303 (i.e., NO at step 303), the operation proceeds to step 304. At step 304, the values α0 to αn−1, which are stored in the storage cells A0 to An−1, respectively, are transferred to the adjacent downstream side cells, respectively, without any modification. Also, at the same time, the value αn, which is stored in the storage cell An, is discarded (erased). Then, the operation proceeds to step 106 and then to steps 107 to 108.

According to the above modification, when it is determined that the absolute value of the difference between the value α0 stored in the storage cell A0 and the value α1 stored in the next storage cell A1 is equal to or larger than the preset value Q at step 303, the value to be stored in the storage cell A1 is corrected through use of the correction coefficient K. In contrast, when it is determined that the absolute value of the difference between the value α0 stored in the storage cell A0 and the value α1 stored in the next storage cell A1 is smaller than the preset value Q at step 303, the value to be stored in the storage cell A1 is not corrected. In this way, the value αn stored in the downstream end storage cell An can be always used to obtain the appropriate stoichiometric air/fuel ratio in the case where the alcohol concentration is kept generally constant (e.g., a case where the alcohol concentration is kept at 50% before and after the point of 0 ml in FIG. 9) and also in the case where the alcohol concentration change is moderate (e.g., the case where the alcohol concentration is changed from 0% to 50% at the point of 0 ml in FIG. 9). Thereafter, the injection quantity of fuel injected from the injector 10 is determined based on this stoichiometric air/fuel ratio.

The above modification of FIG. 7 may be further modified in a manner similar to that of the second modification. Specifically, the oxygen sensor 16 shown in FIG. 4 may be provided. The oxygen sensor 16 outputs the measurement signal indicating the oxygen concentration of exhaust gas of the engine 1. The controller 3 may adjust the correction coefficient K in a manner similar to the one discussed with reference to the second embodiment. That is, the controller 3 may determine whether an absolute value of the difference between the ethanol concentration value βn+1 and the ethanol concentration value βn is equal to or larger-than the threshold value S. When it is determined that the absolute value of the difference between the value βn and the value βn+1 is equal to or larger than the threshold value S, the controller 3 may correct the correction coefficient K in a manner similar to the one discussed with reference to step 208 of the second embodiment.

Furthermore, in the modification of FIG. 7, it is determined whether the absolute value of the difference between the value α0 stored in the storage cell A0 and the value α1 stored in the next storage cell A1 is equal to or larger than the preset value Q at step 303. Alternatively, there may be provided a separate cell column, is which is similar to the cell column B except the separate cell column has only the storage cells B0 to Bn, which correspond to the passage cells P0 to Pn, respectively and does not have the last storage cell Bn+1. Similar to the cell column B of the second embodiment, the controller 3 stores only the measured values β0 to βn in the storage cells B0 to Bn, respectively, without any modification. At step 303 of FIG. 7, the controller 3 may determine whether an absolute value of a difference between the value β0 stored in the storage cell B0 and the value β1 stored in the next storage cell B1 is equal to or larger than the preset value Q. When the controller 3 determines that the absolute value of the difference between the value β0 stored in the storage cell B0 and the value β1 stored in the next storage cell B1 is equal to or larger than the preset value Q, then the controller 3 proceeds to step 104, at which the value α1 is corrected using the correction coefficient K. Thereafter, the controller 3 proceeds to steps 106 to 108 discussed above. In contrast, when the controller 3 determines that the absolute value of the difference between the value β0 stored in the storage cell B0 and the value β1 stored in the next storage cell B1 is smaller than the preset value Q, then the controller 3 proceeds to step 304 where the values α0 to αn−1, which are stored in the storage cells A0 to An−1, respectively, are transferred to the adjacent downstream side cells, respectively, without any modification. Thereafter, the controller 3 proceeds to steps 106 to 108 discussed above. Thus, the stoichiometric air/fuel ratio is determined based on the value αn stored in the storage cell An, and the target injection quantity of fuel of the injector is determined based on this stoichiometric air/fuel ratio. Even in this way, the advantages similar to those discussed with reference to the first embodiment and the modification of FIG. 7 can be achieved.

In the above embodiments and modifications thereof, steps 102, 202 and 301 may correspond to a fuel consumption computing means, and steps 103-106, 204-209, 303-304 may correspond to a fuel property estimating means. Furthermore, steps 107-108, 210-211 may correspond to an injector driving means.

In the above embodiments and modifications thereof, the alcohol concentration, the stoichiometric air/fuel ratio or the target air/fuel ratio discussed above may serve as a fuel specific value of the present invention. Furthermore, each of the storage cells of the storage device 3a is designed to store the corresponding alcohol concentration in the above embodiments and modifications thereof. Alternatively, each of the storage cells of the storage device 3a may be designed to store the stoichiometric/air fuel ratio derived from the corresponding alcohol concentration. In such a case, a difference between the stoichiometric air/fuel ratio of the one storage cell and the stoichiometric air/fuel ratio of the adjacent downstream side storage cell may be computed to determine whether the subsequently computed one of the stoichiometric air/Fuel ratios needs to be corrected in a manner that reduces the difference. Then, the fuel injection of the injector may be carried out based on this subsequently computed one of the stoichiometric air/fuel ratios when the fuel, which corresponds to this subsequently computed one of the stoichiometric air/fuel ratios, reaches the injector, i.e., when the fuel, which corresponds to this subsequently computed one of the stoichiometric air/fuel ratios, is injected from the injector.

In the above embodiments and modifications thereof, it is assumed that the alcohol concentration of the fuel is increased, for example, in the manner shown in FIG. 9. However, the present invention is also equally applicable to a case where the alcohol concentration of the fuel is decreased stepwise, for example, from 50% to 0% or any other percentage to another percentage.

Additional advantages and modifications will readily occur to those skilled in the art. The invention in its broader terms is therefore not limited to the specific details, representative apparatus, and illustrative examples shown and described.

What is claimed is:

1. A fuel supply system for an internal combustion engine, which is adapted to use a mixture of a plurality types of combustible liquids as its fuel, the fuel supply system comprising:
a fuel pump that pumps fuel from a fuel tank;
an injector that is installed to the internal combustion engine and injects the fuel received from the fuel pump into a combustion chamber of the internal combustion engine;
a fuel supply line that communicates between the fuel pump and the injector;
a fuel property sensor that is installed to the fuel supply line and outputs a measurement signal indicating a property of the fuel that flows through the fuel supply line;
a fuel consumption computing means for computing a consumed quantity of fuel, which is consumed by the internal combustion engine;
a fuel property estimating means for computing a fuel property value of the fuel based on a measurement signal received from the fuel property sensor every time the consumed quantity of fuel reaches a value equal to a volume of each of a plurality of imaginary passage cells, which have equal volumes, respectively, and are arranged one after another in a flow direction of the fuel in a portion of the fuel supply line that extends from the fuel property sensor to the injector, wherein:
the fuel property estimating means stores the computed fuel property value as a current fuel property value associated with a first one of the plurality of imaginary passage cells, which is closest to the fuel property sensor among the plurality of imaginary passage cells;
the fuel property estimating means sequentially shifts each fuel property value stored in association with a corresponding one of the plurality of imaginary passage cells as a fuel property value associated with an adjacent downstream side one of the plurality of imaginary passage cells located on a downstream side thereof every time the consumed quantity of fuel reaches the value equal to the volume of each imaginary passage cell; and
when the fuel property estimating means shifts the fuel property value associated with the first one of the plurality of imaginary passage cells as a fuel property value associated with a second one of the plurality of imaginary passage cells located on the downstream side of the first one of the plurality of imaginary passage cells, the fuel property estimating means corrects the fuel property value associated with the second one of the plurality of imaginary passage cells by computing a difference between the fuel property value associated with the first one of the plurality of imaginary passage cells and the fuel property value associated with the second one of the plurality of imaginary passage cells and multiplying the difference by a correction coefficient; and
an injector driving means for driving the injector, wherein:
the injector driving means computes a stoichiometric air/fuel ratio based on the fuel property value, which is associated with a last one of the plurality of imaginary passage cells that is closest to the injector among the plurality of imaginary passage cells, and then computes an injection quantity of fuel based on the computed stoichiometric air/fuel ratio; and
the injector driving means drives the injector based on the computed injection quantity of fuel.

2. The fuel supply system according to claim 1, wherein the correction coefficient is larger than 0 and is smaller than 1.

3. The fuel supply system according to claim 1, further comprising an oxygen sensor, which senses an oxygen concentration of exhaust gas of the internal combustion engine, wherein:
the fuel property estimating means computes an actual air/fuel ratio of the internal combustion engine based on the oxygen concentration, which is sensed with the oxygen sensor;
the fuel property estimating means computes a fuel property value of the fuel conducted through the fuel supply line based on the actual air/fuel ratio; and
the fuel property estimating means corrects the correction coefficient based on the fuel property value, which is computed based on the measurement signal of the fuel property sensor, and the fuel property value, which is computed based on the actual air fuel ratio.

4. The fuel supply system according to claim 3, wherein when a difference between the current fuel property value of the fuel and a previous fuel property value of the fuel, which are computed by the fuel property estimating means, is larger than a predetermined value, the fuel property estimating means corrects the correction coefficient based on the fuel property value, which is computed based on the measurement signal of the fuel property sensor, and the fuel property value, which is computed based on the actual air fuel ratio.

5. A fuel supply system for an internal combustion engine, which is adapted to use any one of alcohol fuel, non-alcohol liquid fuel and a mixture of the alcohol fuel and the non-alcohol liquid fuel as its fuel, the fuel supply system comprising:
an injector that is installed to the internal combustion engine and injects fuel into a combustion chamber of the internal combustion engine;
a fuel supply line that supplies the fuel to the injector;
an alcohol concentration sensor that is installed to the fuel supply line and outputs a measurement signal, which indicates an alcohol concentration of the fuel conducted through the fuel supply line; and
a controller that computes and stores a fuel-specific value, which is one of the alcohol concentration of the fuel and a value derived from the alcohol concentration of the fuel, based on the measurement signal received from the alcohol concentration sensor every time the internal combustion engine consumes a predetermined quantity of fuel through injection of the fuel from the injector, so that a plurality of fuel-specific values is stored in the controller after execution of the computation of the fuel-specific value a plurality of times, wherein:
when the controller determines that a difference between one of the plurality of fuel-specific values and a subsequently computed one of the plurality of fuel-specific values is equal to or larger than a preset value, the controller corrects the subsequently computed one of the plurality of fuel-specific values in a manner that reduces the difference between the one of the plurality of fuel-specific values and the subsequently computed one of the plurality of fuel-specific values; and
the controller controls fuel injection of the injector based on the subsequently computed one of the plurality of fuel-specific values at time of injecting the fuel, which corresponds to the subsequently computed one of the plurality of fuel-specific values.

6. The fuel supply system according to claim 5, wherein when the controller determines that the difference between one of the plurality of fuel-specific values and the subsequently computed one of the plurality of fuel-specific values is smaller than the preset value, the controller does not correct the subsequently computed one of the plurality of fuel-specific values.

7. The fuel supply system according to claim 5, wherein the controller includes a storage device that has a plurality of first-in first-out storage cells, each of which stores a corresponding one of the plurality of fuel specific values.

8. The fuel supply system according to claim 5, further comprising an oxygen sensor, which outputs a measurement signal indicating an oxygen concentration of exhaust gas of the internal combustion engine, wherein the controller uses a correction coefficient, which is set based on the measurement signal of the oxygen sensor, to correct the subsequently computed one of the plurality of fuel-specific values under a predetermined condition.

9. A fuel supply control method for controlling fuel supply at an internal combustion engine, which is adapted to use any one of alcohol fuel, non-alcohol liquid fuel and a mixture of the alcohol fuel and the non-alcohol liquid fuel as its fuel, the fuel supply control method comprising:
computing and storing a fuel-specific value, which is one of an alcohol concentration of the fuel and a value derived from the alcohol concentration of the fuel, based on a measurement signal received from an alcohol concentration sensor installed to a fuel supply line connected to an injector every time the internal combustion engine consumes a predetermined quantity of fuel through injection of the fuel from the injector, so that a plurality of fuel-specific values is stored after execution of the computation of the fuel-specific value a plurality of times;
computing a difference between one of the plurality of fuel-specific values and a subsequently computed one of the plurality of fuel-specific values;
correcting the subsequently computed one of the plurality of fuel-specific values in a manner that reduces the difference between the one of the plurality of fuel-specific values and the subsequently computed one of the plurality of fuel-specific values when the difference between the one of the plurality of fuel-specific values and the subsequently computed one of the plurality of fuel-specific values is equal to or larger than a preset value; and
controlling fuel injection of the injector based on the subsequently computed one of the plurality of fuel-specific values at time of injecting the fuel, which corresponds to the subsequently computed one of the plurality of fuel-specific values.

10. The fuel supply control method according to claim 9, further comprising maintaining the subsequently computed one of the plurality of fuel-specific values without correcting the subsequently computed one of the plurality of fuel specific values when the difference between the one of the plurality of fuel-specific values and the subsequently computed one of the plurality of fuel-specific values is smaller than a preset value.
